(19) United States
(12) Patent Application Publication
(10) Pub. No.: US 2008/0135105 A1
(43) Pub. Date: Jun. 12, 2008

(54) Fluid Recovery System of Molding System

(75) Inventor: Peter Anthony LACZA, North York (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, omitted

(73) Assignee: HUSKY INJECTION MOLDING SYSTEMS LTD., Bolton (CA)

(21) Appl. No.: 11/608,048

(22) Filed: Dec. 7, 2006

(51) Int. Cl. D06F 39/08; B28B 1/14; B32B 3/26

(52) U.S. Cl. 137/312; 264/299; 264/135

(57) ABSTRACT

Disclosed are: (i) a fluid recovery system of a molding system, (ii) a molding system including a fluid recovery system, (iii) a method of a molding system having a fluid recovery system, (iv) a molded article manufactured by usage of a fluid recovery system of a molding system, (v) a molded article manufactured by usage of a molding system including a fluid recovery system, (vi) a molded article manufactured by usage of method of a molding system having a fluid recovery system.

### TECHNICAL FIELD

The present invention generally relates to, but is not limited to, molding systems, and more specifically the present invention relates to, but is not limited to, (i) a fluid recovery system of a molding system, (ii) a molding system including a fluid recovery system, (iii) a method of a molding system having a fluid recovery system, (iv) a molded article manufactured by usage of a fluid recovery system of a molding system, (v) a molded article manufactured by usage of a molding system including a fluid recovery system, (vi) a molded article manufactured by usage of method of a molding system having a fluid recovery system.

### BACKGROUND

Examples of known molding systems are (amongst others): (i) the HyPET™ Molding System, (ii) the Quadloc™ Molding System, (iii) the Hylectric™ Molding System, and (iv) the HyMet™ Molding System, all manufactured by Husky Injection Molding Systems Limited (Location: Bolton, Ontario, Canada; www.husky.ca).

U.S. Pat. No. 6,224,345 (Inventor: Dussault; Published: 2001 May 1) discloses an automatic fluid recovery system that has an orifice in a venturi tube through which a vacuum is drawn for drawing a fluid into a reservoir when a valve is opened. More specifically, this patent appears to disclose a pressure/vacuum generator that is established by coupling a pressure port of a vacuum generator to an air pressure source while coupling a valve in fluid communication with an exhaust port of the vacuum generator. When the valve is in a normally open condition (i.e., the exhaust vented to atmosphere), the vacuum port of the pressure/vacuum generator generates a vacuum. When the valve is closed, thereby closing off the exhaust port, the vacuum port becomes a pressure port. Thus, this pressure/vacuum generator can be used in any number of fluid (liquid and gas) systems (e.g., fluid recovery system, fluid transfer system, etc.) that require both a pressure source and a vacuum source while using a minimum number of components.

### SUMMARY

According to a first aspect of the present invention, there is provided a fluid recovery system of a molding system having a pump, a main fluid system including an escape point, an air-supply connection configured to be connected to an air supply, the fluid recovery system including a reservoir including: (i) an inlet configured to be coupled to the escape point; (ii) an outlet configured to be coupled to the main fluid system; (iii) an exit port configured to be coupled to the pump; and (iv) an input port configured to be coupled to the air-supply connection.

According to a second aspect of the present invention, there is provided a fluid recovery system of a molding system having a pump, a main fluid system including an escape point, an air-supply connection configured to be connected to an air supply, the fluid recovery system including a reservoir including: (i) an inlet coupled to the escape point; (ii) an outlet coupled to the main fluid system; (iii) an exit port coupled to the pump; and (iv) an input port coupled to the air-supply connection.

According to a third aspect of the present invention, there is provided a molding system, including: a pump; a main fluid system including an escape point; an air-supply connection configured to be connected to an air supply; and a fluid recovery system, including a reservoir including: (i) an inlet coupled to the escape point; (ii) an outlet coupled to the main fluid system; (iii) an exit port coupled to the pump; and (iv) an input port coupled to the air-supply connection.

According to a fourth aspect of the present invention, there is provided a method of a molding system having a pump, a main fluid system including an escape point, an air-supply connection configured to be connected to an air supply, and a fluid recovery system, the fluid recovery system including a reservoir, the reservoir including an inlet, an outlet, an exit port, and an input port, the method including: (i) coupling the inlet to the escape point; (ii) coupling the outlet coupled to the main fluid system; (iii) coupling the exit port coupled to the pump; and (iv) coupling the input port coupled to the air-supply connection.

According to a fifth aspect of the present invention, there is provided a molded article manufactured by usage of a fluid recovery system of a molding system having a pump, a main fluid system including an escape point, an air-supply connection configured to be connected to an air supply, the fluid recovery system including a reservoir including: (i) an inlet configured to be coupled to the escape point; (ii) an outlet configured to be coupled to the main fluid system; (iii) an exit port configured to be coupled to the pump; and (iv) an input port configured to be coupled to the air-supply connection.

According to a sixth aspect of the present invention, there is provided a molded article manufactured by usage of a molding system, the molding system including a pump; a main fluid system including an escape point; an air-supply connection configured to be connected to an air supply; and a fluid recovery system, including a reservoir including: (i) an inlet coupled to the escape point; (ii) an outlet coupled to the main fluid system; (iii) an exit port coupled to the pump; and (iv) an input port coupled to the air-supply connection.

According to a seventh aspect of the present invention, there is provided a molded article manufactured by usage of method of a molding system having a pump, a main fluid system including an escape point, an air-supply connection configured to be connected to an air supply, and a fluid recovery system, the fluid recovery system including a reservoir, the reservoir including an inlet, an outlet, an exit port, and an input port, the method including: (i) coupling the inlet to the escape point; (ii) coupling the outlet coupled to the main fluid system; (iii) coupling the exit port coupled to the pump; and (iv) coupling the input port coupled to the air-supply connection.

A technical effect, amongst other technical effects, of the aspects of the present invention is economical implementation of a fluid recovery system of a molding system.

### BRIEF DESCRIPTION OF THE DRAWINGS

A better understanding of the exemplary embodiments of the present invention (including alternatives and/or variations thereof) may be obtained with reference to the detailed description of the exemplary embodiments of the present invention along with the following drawings, in which:

FIGS. 1A and 1B are schematic representations of a fluid recovery system of a molding system according to a first exemplary embodiment;

FIGS. 2A, 2B and 2C are schematic representations of a fluid recovery system of a molding system according to a second exemplary embodiment (which is the preferred embodiment);

FIG. 3 is a schematic representation of a fluid recovery system of a molding system according to a third exemplary embodiment;

FIG. 4 is a schematic representation of a fluid recovery system of a molding system according to a fourth exemplary embodiment;

FIG. 5 is a schematic representation of a fluid recovery system of a molding system according to a fifth exemplary embodiment; and

FIGS. 6A and 6B are schematic representations of a fluid recovery system of a molding system according to a sixth exemplary embodiment.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

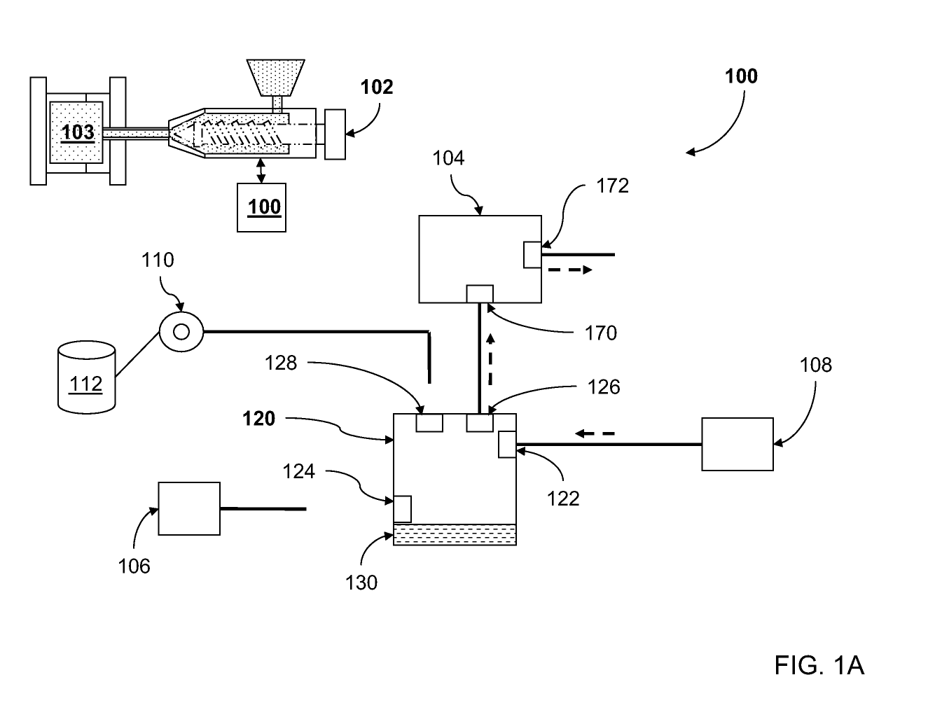

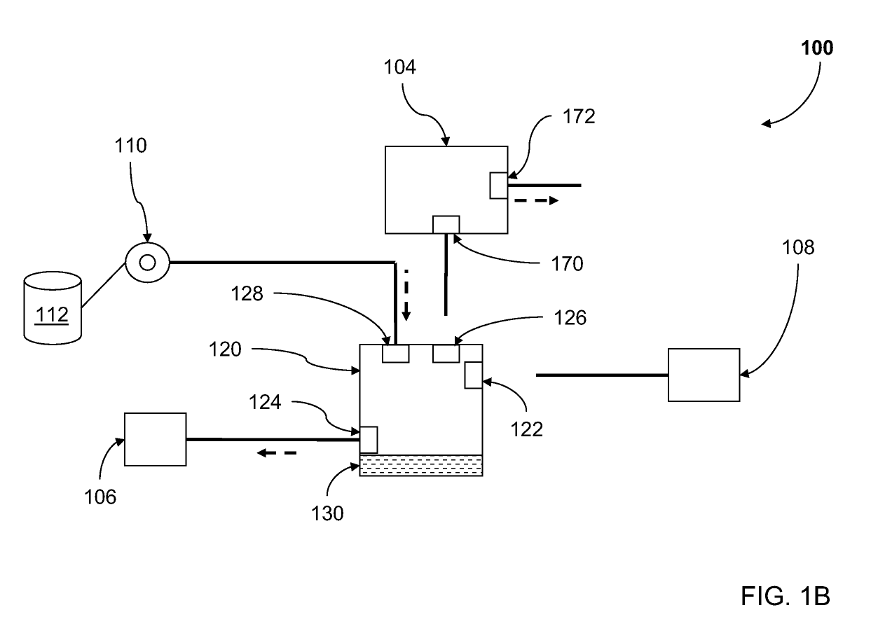

FIGS. 1A and 1B are schematic representations of a fluid recovery system 100 of a molding system 102 according to a first exemplary embodiment. In the upper left hand side of FIG. 1A, there is depicted a schematic representation of the molding system 102 that is used to mold a molded article 103. The molding system 102 includes components, such as a hopper attached to an extruder so as to feed a molding material to the extruder, and a machine nozzle connecting the extruder to a mold that is held or supported by platens so that the molding material prepared by the extruder may be injected or transported into the mold. According to a variant, a hot runner (not depicted) is interposed between the machine nozzle and the mold. These elements are known to persons skilled in the art and as such these known elements will not be described here in detail; these known components are described, at least in part, in the following books (by way of example): (i) Injection Molding Handbook by Osswald/Turng/Gramann (ISBN: 3-446-21669-2; publisher: Hanser), and (ii) Injection Molding Handbook by Rosato and Rosato (ISBN: 0-412-99381-3; publisher: Chapman & Hill).

The molding system 102 has: (i) a pump 104, (ii) a main fluid system 106 that includes an escape point 108 (that is, a point from which a fluid, such as a hydraulic fluid, leaks from the main fluid system 106), (iii) an air-supply connection 110 that is configured to be connected to an air supply 112, and (iv) the fluid recovery system 100. The fluid recovery system 100 permits: (i) recovery of fluid from the escape point 108 and (ii) placement of the recovered fluid back into the main fluid system 106. It will be appreciated that: (i) the air supply 112 is not normally sold or supplied with the molding system 102 (that is, the end user of the molding system 102 provides the air supply 112), (ii) the molding system 102 and the fluid recovery system 100 may be supplied together (that is, supplied by a single vendor) or may be supplied separately (that is, molding system 102 and the fluid recovery system 100 are sold by separate vendors; that is, the fluid recovery system 100 is sold as a retrofit kit for use in an existing molding system 102).

In the form of a retrofit kit, the fluid recovery system 100 has a reservoir 120, and the reservoir 120 includes: (i) an inlet 122 that is configured to be coupled to the escape point 108, (ii) an outlet 124 that is configured to be coupled to the main fluid system 106, (iii) an exit port 126 that is configured to be coupled to the pump 104 (that is, coupled to a pump input 170 of the pump 104), and (iv) an input port 128 that is configured to be coupled to the air-supply connection 110. Once the fluid recovery system 100 is installed in the molding system 102, then (i) the inlet 122 is coupled to the escape point 108, (ii) the outlet 124 is coupled to the main fluid system 106, (iii) the exit port 126 is coupled to the pump 104, and (iv) the input port 128 is coupled to the air-supply connection 110. A method of retrofitting an existing molding system 102 and/or fitting the molding system 102 includes: (i) coupling the inlet 122 to the escape point 108, (ii) coupling the outlet 124 coupled to the main fluid system 106, (iii) coupling the exit port 126 coupled to the pump 104, and (iv) coupling the input port 128 coupled to the air-supply connection 110. The pump 104 includes a pump output 172 that is vented to atmosphere. The inlet 122 is configured to be switchably coupled to the escape point 108, and the outlet 124 is configured to be switchably coupled to the main fluid system 106.

Referring to FIG. 1A, once the pump 104 is connected to the reservoir 120, the pump 104 may be actuated so as to remove air from the reservoir 120 (so as to generate or create a vacuum in the reservoir 120). A fluid-pull operational sequence is as follows: (i) the inlet 122 is coupled to the escape point 108, (ii) the air supply 112 is decoupled from the reservoir 120, (iii) the outlet 124 is decoupled from the main fluid system 106, and (iv) the pump 104 is actuated to remove air from the reservoir 120 so that the pump 104 creates or generates a vacuum in the reservoir 120, the vacuum generated has sufficient strength so as to cause fluid transfer from the escape point 108 to the reservoir 120 (via the inlet 122).

Referring to FIG. 1B, a fluid-push operational sequence is as follows: (i) the input port 128 of the reservoir 120 is coupled to the air-supply connection 110, (ii) the air-supply connection 110 is connected to the air supply 112, (iii) the outlet 124 is coupled to the main fluid system 106, and (iv) the air supply 112 is actuated to deliver air into the reservoir 120 so that the air located in the reservoir 120 becomes pressurized with sufficient strength so as to cause fluid transfer from the reservoir 120 to the main fluid system 106 (via the outlet 124).

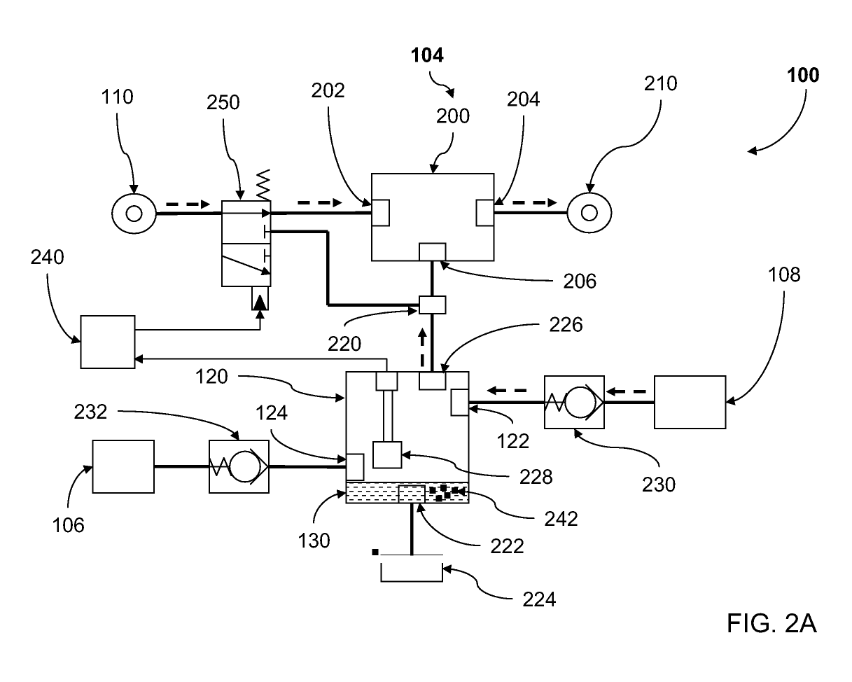

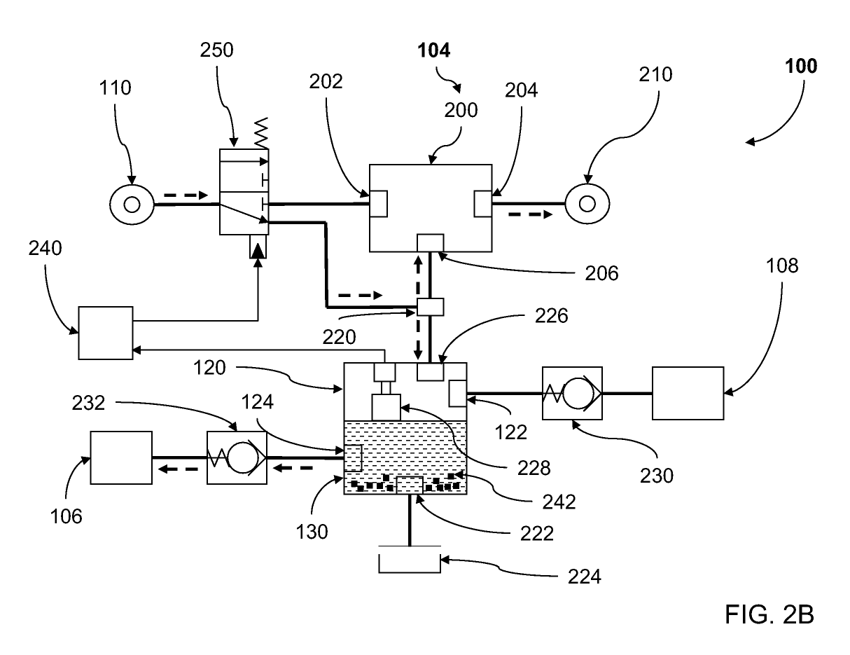

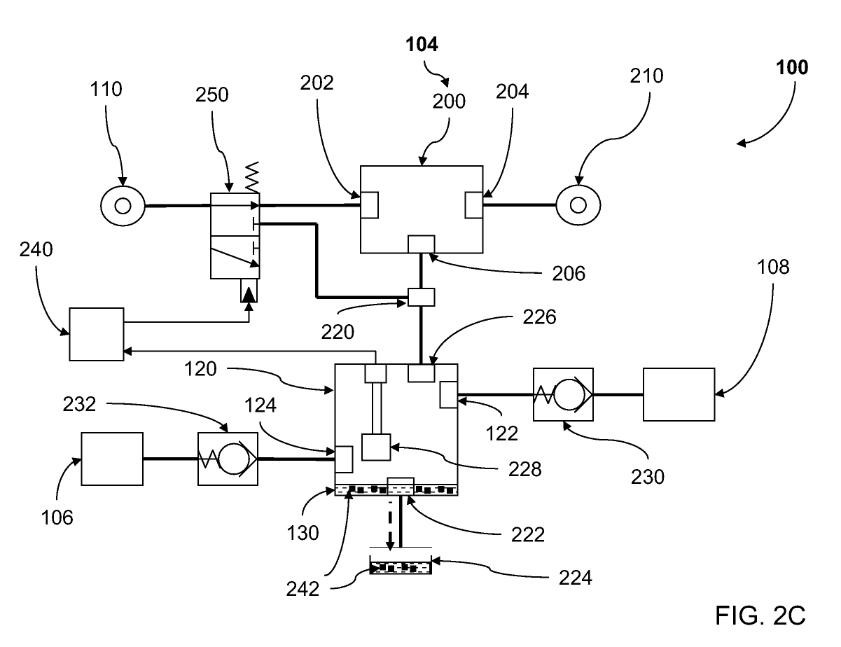

FIGS. 2A, 2B and 2C are schematic representations of the fluid recovery system 100 of the molding system 102 according to the second exemplary embodiment (which is the preferred embodiment). Preferably, the pump 104 includes a vacuum generator 200. An example of the vacuum generator 200 is described in U.S. Pat. No. 6,224,345 (Inventor: Dussault; Filed 22 Mar. 1999).

The exit port 126 and the input port 128 (of FIGS. 1A and 1B) are combined into a bi-directional input port 226. The bi-directional input port 226 is configured to be coupled to a connection 220 (such as a “T”-connection). The connection 220 is configured to be: (i) coupled to the pump 104 (that is, the vacuum generator 200), and (ii) switchably coupled to the air-supply connection 110; more specifically, the connection 220 is configured to be connected to the air-supply connection 110 via the switch 250. In a first state, the switch 250 connects the air-supply connection 110 to the connection 220; in a second state, the switch 250 connects the air-supply connection 110 to a pressure port 202 of a vacuum generator 200. The switch 250 is controllably connected to the controller 240 so that the controller 240 may controllably change the state of the switch 250 between a first switch state and a second switch state.

The vacuum generator 200 includes: (i) the pressure port 202 that is configured to be coupled to the air-supply connection 110, (ii) an exhaust port 204 that is configured to be coupled to an air exhaust 210, and (iii) a venturi port 206 that is configured to be coupled to the connection 220. The pressure port 202 is configured to be switchably connected to the air-supply connection 110 (more specifically, the pressure port 202 is configured to be connected to the air-supply 110 via the switch 250). The exhaust port 204 is configured to be directly coupled to an air exhaust 210. The venturi port 206 is configured to be coupled (preferably, directly coupled) to the connection 220.

The inlet 122 is configured to be coupled to the escape point 108 via an inlet check valve 230. The inlet check valve 230 (i) permits flow of fluid from the escape point 108 into the reservoir 120 while (ii) blocking flow of the fluid from the reservoir 120 to the escape point 108). The outlet 124 is configured to be coupled to the main fluid system 106 via an outlet check valve 232. The outlet check valve 232 (i) permits flow of the fluid from the reservoir 120 to the main fluid system 106, while (ii) blocking flow of the fluid from the main fluid system 106 to the reservoir 120.

The reservoir 120 is configured to accommodate a float 228. The float 228 is configured to be coupled (interfaced) to the controller 240. The float 228 is configured to indicate fluid level in the reservoir 120 to the controller 240.

Referring to FIG. 2A, the switch 250 is depicted in the first switch state; in the first switch state, the switch 250 (i) connects the air supply connection 110 to the pressure port 202 and (ii) disconnects the air-supply connection 110 from the connection 220. Responsive to not receiving a predetermined indication from the float 228, the controller 240 maintains the state of the switch 250 in the first switch state.

Referring to FIG. 2B, the switch 250 is depicted in the second switch state; in the second switch state, the switch 250 (i) disconnects the air supply connection 110 from the pressure port 202 and (ii) connects the air-supply connection 110 to the connection 220. Responsive to receiving a predetermined indication from the float 228, the controller 240 changes the state of the switch 250 between the first switch state and the second switch state.

Referring to FIG. 2C, leaked fluid 130 that resides in the reservoir 120 may have metal particulates 242 that were carried by the fluid 130 from the escape point 108 to the reservoir 120; for such this situation, the reservoir 120 also includes a recovery outlet 222 that is configured to drain (that is the outlet 222 includes a valve or removable plug, etc) some of the leaked fluid 130 and all or most of the metal particulates 242 from the reservoir 120 to a collector 224 after (i) the switch 250 is placed in the first switch state so that air is not transferred from the air-supply connection 110 to the reservoir 120, (ii) the vacuum generator 200 is de-actuated so that a vacuum is not generated in the reservoir 120, and (iii) the reservoir 120 is connected to ambient pressure.

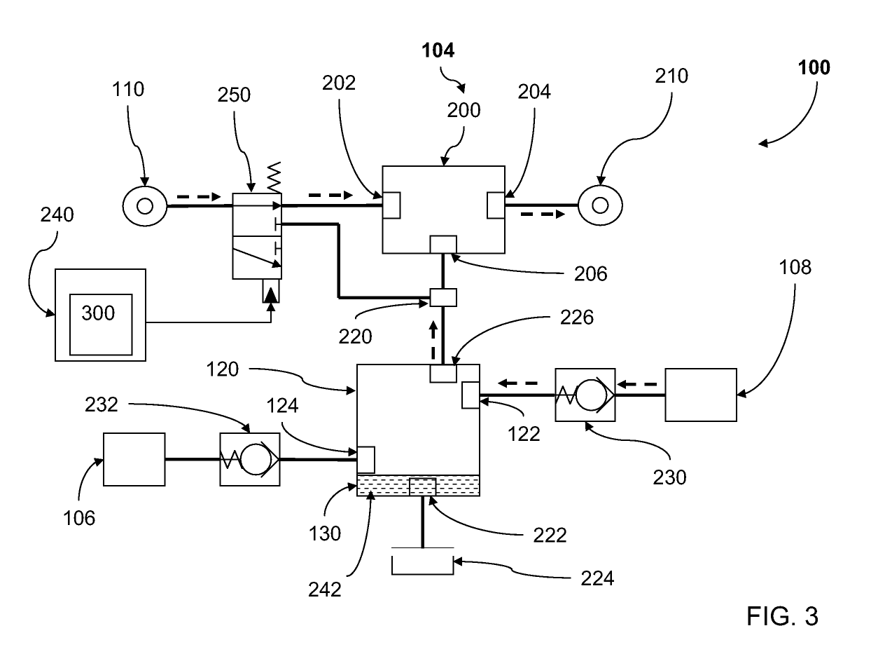

FIG. 3 is a schematic representation of the fluid recovery system 100 of the molding system 102 according to the third exemplary embodiment in which the controller 240 includes a timer 300. The timer 300 is used to count a predetermined time interval; responsive to the timer 300 counting the predetermined time interval, the controller 240 changes the state of the switch 250 between the first switch state and the second switch state. Responsive to the timer 300 not counting the predetermined time interval, the controller 240 maintains the state of the switch 250 in the first switch state.

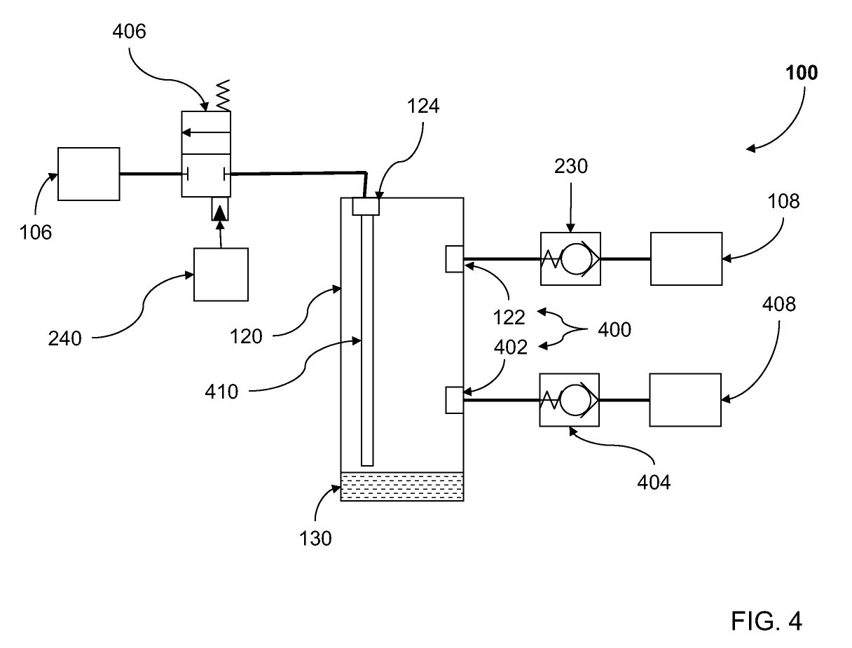

FIG. 4 is a schematic representation of the fluid recovery system 100 of the molding system 102 according to the fourth exemplary embodiment in which the reservoir 120 includes a plurality of inlets 400. The inlets 400 are depicted one above the other for sake of convenient illustration of the fourth exemplary embodiment; however, it is understood that the inlets 400 may be at the same (or near same) level located above the leaked fluid 130 (preferably, closer to the top of the reservoir 120). Each inlet of the plurality of inlets 400 is configured to be switchably coupled to a respective escape point of the main fluid system 106. The outlet 124 is configured to be coupled to the main fluid system 106 via an outlet switch 406. The outlet switch 406 is configured to be controllably connectable to the controller 240. The outlet switch 406 has a first switch state and a second switch-state. The controller 240 controllably changes the state of the outlet switch 406 between the first switch state and the second switch state. In the first switch state, the outlet switch 406 connects the outlet 124 to the main fluid system 106. In the second switch state, the outlet switch 406 disconnects the outlet 124 from the main fluid system 106.

According to the fourth exemplary embodiment, the outlet 124 is positioned at the top (or near top) of the reservoir 120, and an elongated tube 410 extends from the outlet 124 to the bottom area of the reservoir 120. According to the other embodiments, the outlet 124 may be placed at the bottom (or near bottom) of the reservoir 120 as depicted in FIGS. 1A, 1B, 2A, 2B, 2C and 3.

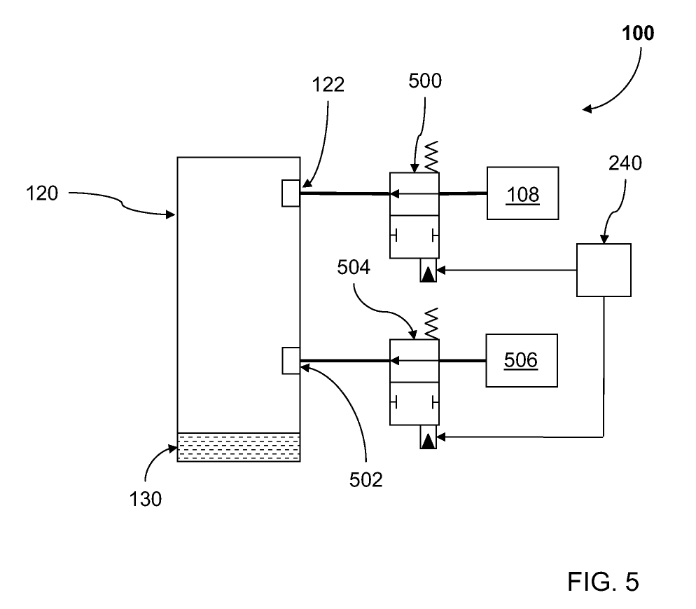

FIG. 5 is a schematic representation of the fluid recovery system 100 of the molding system 102 according to the fifth exemplary embodiment in which the inlet 122 is configured to connect to the escape point 108 via an inlet switch 500. The inlet switch 500 is configured to be controllably connected to a controller 240. The inlet switch 500 has a first switch state and a second switch-state. The controller 240 is configured to change the state of the inlet switch 500 between the first switch state and the second switch state. In the first switch state, the inlet switch 500 connects the inlet 122 to the escape point 108. In the second switch state, the inlet switch 500 disconnects the inlet 122 from the escape point 108.

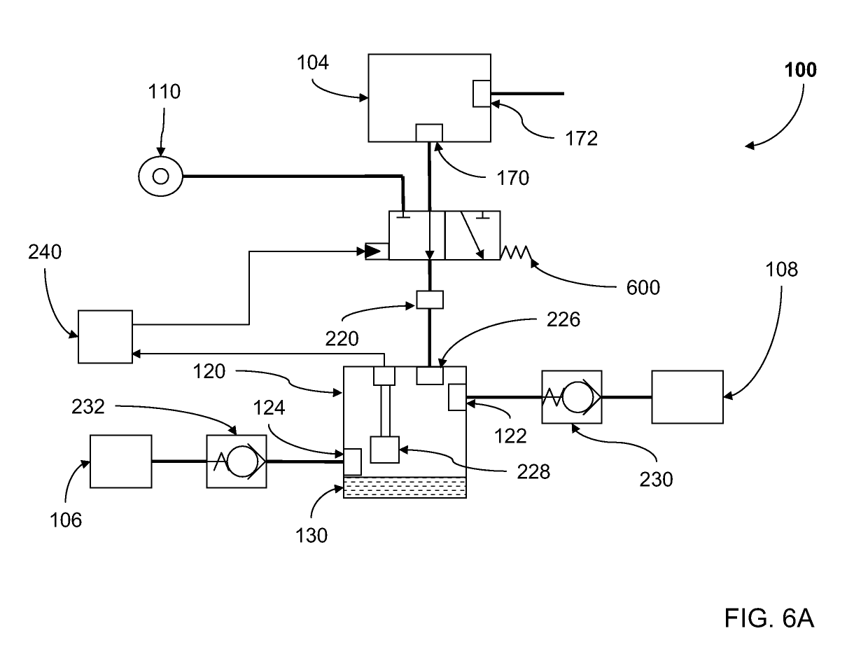

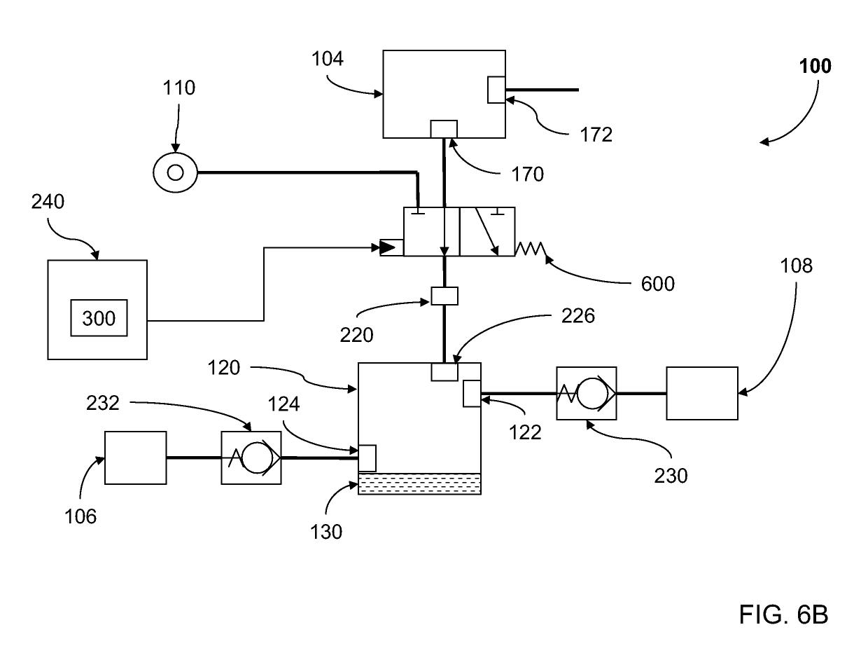

FIGS. 6A and 6B are schematic representations of the fluid recovery system 100 of the molding system 102 according to the sixth exemplary embodiment in which (i) the vacuum generator 200 is replaced by the pump 104, and (ii) the switch 250 is replaced by a switch 600.

FIG. 6A depicts a first variant of the sixth embodiment in which the connection 220 is configured to be coupled to the output side of the switch 600. The switch 600 has inputs of which one of the inputs is coupled to the pump 104 while the other input is coupled to the air-supply connection 110. The switch 600 is controllably connected to the controller 240 so that the controller 240 may controllably change the state of the switch 600 between a first switch state and a second switch state.

Referring to FIG. 6A, in the first switch state, the switch 600 disconnects the air supply connection 110 from the connection 220 and connects the pump 104 to the connection 220. In the second switch state (not depicted), the switch 600 connects the air supply connection 110 to the connection 220 and disconnects the vacuum 104 from the connection 220. Responsive to receiving a predetermined indication from the float 228, the controller 240 changes the state of the switch 600 between the first switch state and the second switch state. Responsive to not receiving a predetermined indication from the float 228, the controller 240 maintains the state of the switch 600 in the first switch state.

FIG. 6B depicts a second variant of the sixth embodiment in which (i) the controller 240 includes the timer 300, and (ii) the float 228 is not used. The timer 300 is configured to count a predetermined time interval. Responsive to the timer 300 counting the predetermined time interval, the controller 240 changes the state of the switch 600 between the first switch state and the second switch state. Responsive to the timer 300 not counting the predetermined time interval, the controller 240 maintains the state of the switch 600 in the first switch state. This arrangement permits periodic blow out of the reservoir 120 without having to wait for the reservoir 120 to fill up (as may be required by the variant according to FIG. 6A).

The description of the exemplary embodiments provides examples of the present invention, and these examples do not limit the scope of the present invention. It is understood that the scope of the present invention is limited by the claims. The exemplary embodiments described above may be adapted for specific conditions and/or functions, and may be further extended to a variety of other applications that are within the scope of the present invention. Having thus described the exemplary embodiments, it will be apparent that modifications and enhancements are possible without departing from the concepts as described. It is to be understood that the exemplary embodiments illustrate the aspects of the invention. Reference herein to details of the illustrated embodiments is not intended to limit the scope of the claims. The claims themselves recite those features regarded as essential to the present invention. Preferable embodiments of the present invention are subject of the dependent claims. Therefore, what is to be protected by way of letters patent are limited only by the scope of the following

What is claimed is:

1. A fluid recovery system of a molding system having a pump, a main fluid system including an escape point, an air-supply connection configured to be connected to an air supply, the fluid recovery system comprising:
a reservoir including:
an inlet configured to be coupled to the escape point;
an outlet configured to be coupled to the main fluid system;
an exit port configured to be coupled to the pump; and
an input port configured to be coupled to the air-supply connection.

2. The fluid recovery system of claim 1, wherein in a fluid-pull operational sequence:
(i) the inlet is coupled to the escape point,
(ii) the air supply is decoupled from the reservoir,
(iii) the outlet is decoupled from the main fluid system, and
(iv) the pump is actuatable to remove air from the reservoir so that the pump creates or generates a vacuum in the reservoir, the vacuum generated has sufficient strength so as to cause fluid transfer from the escape point to the reservoir via the inlet.

3. The fluid recovery system of claim 1, wherein in a fluid-push operational sequence:
(i) the input port of the reservoir is coupled to the air-supply connection,
(ii) the air-supply connection is connected to the air supply,
(iii) the outlet is coupled to the main fluid system, and
(iv) the air supply is actuatable to deliver air into the reservoir so that the air located in the reservoir becomes pressurized with sufficient strength so as to cause fluid transfer from the reservoir to the main fluid system via the outlet.

4. The fluid recovery system of claim 1, wherein the inlet is configured to be switchably coupled to the escape point.

5. The fluid recovery system of claim 1, the outlet is configured to be switchably coupled to the main fluid system.

6. The fluid recovery system of claim 1, wherein the exit port and the input port are combined into a bi-directional input port.

7. The fluid recovery system of claim 1, wherein the exit port and the input port are combined into a bi-directional input port, the bi-directional input port configured to be connected to a connection.

8. The fluid recovery system of claim 1, wherein the exit port and the input port are combined into a bi-directional input port, the bi-directional input port configured to be connected to a connection, the connection configured to be coupled to the pump, the pump includes a vacuum generator.

9. The fluid recovery system of claim 1, wherein the exit port and the input port are combined into a bi-directional input port, the bi-directional input port configured to be connected to a connection, the connection configured to be coupled to the pump, the pump includes a vacuum generator, the vacuum generator includes:
a pressure port configured to be coupled to the air-supply connection;
an exhaust port configured to be coupled to an air exhaust; and
a venturi port configured to be coupled to the connection.

10. The fluid recovery system of claim 1, wherein the exit port and the input port are combined into a bi-directional input port, the bi-directional input port configured to be connected to a connection, the connection configured to be coupled to the pump, the pump includes a vacuum generator, the connection is configured to be coupled to the air-supply connection.

11. The fluid recovery system of claim 1, wherein the exit port and the input port are combined into a bi-directional input port, the bi-directional input port configured to be connected to a connection, the connection configured to be coupled to the pump, the pump includes a vacuum generator, the vacuum generator includes:
a pressure port configured to be switchably connected to the air-supply connection;
an exhaust port configured to be directly coupled to an air exhaust; and
a venturi port configured to be directly coupled to the connection, the connection is configured to be switchably connected to the air-supply connection.

12. The fluid recovery system of claim 1, wherein the exit port and the input port are combined into a bi-directional input port, the bi-directional input port configured to be connected to a connection, the connection configured to be coupled to the pump, the pump includes a vacuum generator, the vacuum generator includes:
a pressure port configured to be connected to the air-supply connection via a switch;
an exhaust port configured to be directly coupled to an air exhaust; and
a venturi port configured to be directly coupled to the connection, the connection is configured to be connected to the air-supply connection via the switch.

13. The fluid recovery system of claim 1, wherein the exit port and the input port are combined into a bi-directional input port, the bi-directional input port configured to be connected to a connection, the connection configured to be coupled to the pump, the pump includes a vacuum generator, the inlet is configured to be switchably coupled to the escape point.

14. The fluid recovery system of claim 1, wherein the exit port and the input port are combined into a bi-directional input port, the bi-directional input port configured to be connected to a connection, the connection configured to be coupled to the pump, the pump includes a vacuum generator, the inlet is configured to be coupled to the escape point via an inlet check valve.

15. The fluid recovery system of claim 1, wherein the exit port and the input port are combined into a bi-directional input port, the bi-directional input port configured to be connected to a connection, the connection configured to be coupled to the pump, the pump includes a vacuum generator, the outlet is configured to be switchably coupled to the main fluid system.

16. The fluid recovery system of claim 1, wherein the exit port and the input port are combined into a bi-directional input port, the bi-directional input port configured to be connected to a connection, the connection configured to be coupled to the pump, the pump includes a vacuum generator, the outlet is configured to be coupled to the main fluid system via an outlet check valve.

17. The fluid recovery system of claim 1, wherein the exit port and the input port are combined into a bi-directional input port, the bi-directional input port configured to be connected to a connection, the connection configured to be coupled to the pump, the pump includes a vacuum generator, the reservoir includes a recovery outlet configured to drain leaked fluid from the reservoir to a collector, the leaked fluid having metal particulates.

18. The fluid recovery system of claim 1, wherein the exit port and the input port are combined into a bi-directional input port, the bi-directional input port configured to be connected to a connection, the connection configured to be coupled to the pump, the pump includes a vacuum generator, the reservoir is configured to accommodate a float, the float configured to be coupled to a controller, the float configured to indicate fluid level in the reservoir to the controller.

19. The fluid recovery system of claim 1, wherein the exit port and the input port are combined into a bi-directional input port, the bi-directional input port configured to be connected to a connection, the connection configured to be coupled to the pump, the pump includes a vacuum generator,
the vacuum generator includes:
a pressure port configured to be connected to the air-supply connection via a switch;
an exhaust port configured to be directly coupled to an air exhaust; and
a venturi port configured to be directly coupled to the connection, the connection is configured to be connected to the air-supply connection via the switch,
the reservoir is configured to accommodate a float, the float configured to be coupled to a controller, the float configured to indicate fluid level in the reservoir to the controller, the switch is controllably connected to the controller,
the switch having a first switch state and also having a second switch state,
in the first switch state, the switch connects the air supply connection to the pressure port and the switch disconnects the air-supply connection from the connection,
in the second switch state, the switch disconnects the air supply connection from the pressure port and the switch connects the air-supply connection to the connection,
responsive to receiving a predetermined indication from the float, the controller changes the state of the switch between the first switch state and the second switch state, and
responsive to not receiving a predetermined indication from the float, the controller maintains the state of the switch in the first switch state.

20. The fluid recovery system of claim 1, wherein the exit port and the input port are combined into a bi-directional input port, the bi-directional input port configured to be connected to a connection, the connection configured to be coupled to the pump, the pump includes a vacuum generator,
the vacuum generator includes:
a pressure port configured to be connected to the air-supply connection via a switch;
an exhaust port configured to be directly coupled to an air exhaust; and
a venturi port configured to be directly coupled to the connection, the connection is configured to be connected to the air-supply connection via the switch,
the switch having a first switch state and also having a second switch state,
in the first switch state, the switch connects the air supply connection to the pressure port and the switch disconnects the air-supply connection from the connection,
in the second switch state, the switch disconnects the air supply connection from the pressure port and the switch connects the air-supply connection to the connection,
the switch is configured to be controllably connected to a controller, the controller includes a timer, the timer configured to count a predetermined time interval,
responsive to the timer counting the predetermined time interval, the controller changes the state of the switch between the first switch state and the second switch state, and
responsive to the timer not counting the predetermined time interval, the controller maintains the state of the switch in the first switch state.

21. The fluid recovery system of claim 1, wherein the exit port and the input port are combined into a bi-directional input port, the bi-directional input port configured to be connected to a connection, the connection configured to be coupled to the pump, the pump includes a vacuum generator, the reservoir includes a plurality of inlets, and each inlet of the plurality of inlets is configured to be switchably coupled to a respective escape point.

22. The fluid recovery system of claim 1, wherein the exit port and the input port are combined into a bi-directional input port, the bi-directional input port configured to be connected to a connection, the connection configured to be coupled to the pump, the pump includes a vacuum generator, the reservoir includes an outlet, the outlet is configured to be coupled to the main fluid system via an outlet switch, the outlet switch is configured to be controllably connectable to a controller, the outlet switch having a first switch state and also having a second switch-state, the controller controllably changes the state of the outlet switch between the first switch state and the second switch state,
in the first switch state, the outlet switch connects the outlet to the main fluid system, and
in the second switch state, the outlet switch disconnects the outlet from the main fluid system.

23. The fluid recovery system of claim 1, wherein the exit port and the input port are combined into a bi-directional input port, the bi-directional input port configured to be connected to a connection, the connection configured to be coupled to the pump, the pump includes a vacuum generator, the inlet is configured to connect to the escape point via an inlet switch.

24. The fluid recovery system of claim 1, wherein the exit port and the input port are combined into a bi-directional input port, the bi-directional input port configured to be connected to a connection, the connection configured to be coupled to the pump, the pump includes a vacuum generator, the inlet is configured to be coupled to the escape point via an inlet switch, the inlet switch is configured to be controllably connected to a controller, the inlet switch having a first switch state and also having a second switch-state, the controller is configured to change the state of the inlet switch from the first switch state to the second switch state,
in the first switch state, the inlet switch connects the inlet to the escape point, and
in the second switch state, the inlet switch disconnects the inlet from the escape point.

25. The fluid recovery system of claim 1, wherein the reservoir includes a plurality of inlets, and each inlet of the plurality of inlets is configured to be switchably coupled to a respective escape point.

26. The fluid recovery system of claim 1, wherein the reservoir includes an outlet, the outlet is configured to be coupled to the main fluid system via an outlet switch, the outlet switch is configured to be controllably connectable to a controller, the outlet switch having a first switch state and also having a second switch-state, the controller controllably changes the state of the outlet switch between the first switch state and the second switch state,
in the first switch state, the outlet switch connects the outlet to the main fluid system, and
in the second switch state, the outlet switch disconnects the outlet from the main fluid system.

27. The fluid recovery system of claim 1, wherein the inlet is configured to connect to the escape point via an inlet switch.

28. The fluid recovery system of claim 1, wherein the inlet is configured to be coupled to the escape point via an inlet switch, the inlet switch is configured to be controllably connected to a controller, the inlet switch having a first switch state and also having a second switch-state, the controller is configured to change the state of the inlet switch from the first switch state to the second switch state,
in the first switch state, the inlet switch connects the inlet to the escape point, and
in the second switch state, the inlet switch disconnects the inlet from the escape point.

29. The fluid recovery system of claim 1, wherein the exit port and the input port are combined into a bi-directional input port, the bi-directional input port configured to be connected to a connection, the connection configured to be coupled to a switch, the switch coupled to a pump input of a pump, the switch coupled to the air-supply connection, a pump output of the pump configured to vent to atmosphere.

30. The fluid recovery system of claim 1, wherein the exit port and the input port are combined into a bi-directional input port, the bi-directional input port configured to be connected to a connection, the connection configured to be coupled to a switch, the switch coupled to a pump input of a pump, the switch coupled to the air-supply connection, a pump output of the pump configured to vent to atmosphere,
the reservoir is configured to accommodate a float, the float configured to be coupled to a controller, the float configured to indicate fluid level in the reservoir to the controller, the switch is controllably connected to the controller,
the switch having a first switch state and also having a second switch state,
in the first switch state, the switch connects the pump to the connection and disconnects the air supply connection from the connection,
in the second switch state, the switch connects the air supply connection to the connection and disconnects the pump from the connection,
responsive to receiving a predetermined indication from the float, the controller changes the state of the switch between the first switch state and the second switch state, and
responsive to not receiving a predetermined indication from the float, the controller maintains the state of the switch in the first switch state.

31. The fluid recovery system of claim 1, wherein the exit port and the input port are combined into a bi-directional input port, the bi-directional input port configured to be connected to a connection, the connection configured to be coupled to a switch, the switch coupled to a pump input of a pump, the switch coupled to the air-supply connection, a pump output of the pump configured to vent to atmosphere,
the switch having a first switch state and also having a second switch state,
in the first switch state, the switch connects the pump to the connection and disconnects the air supply connection from the connection,
in the second switch state, the switch connects the air supply connection to the connection and disconnects the pump from the connection,
the switch is controllably connected to the controller,
the controller includes a timer, the timer configured to count a predetermined time interval,
responsive to the timer counting the predetermined time interval, the controller changes the state of the switch between the first switch state and the second switch state, and
responsive to the timer not counting the predetermined time interval, the controller maintains the state of the switch in the first switch state.

32. A fluid recovery system of a molding system having a pump, a main fluid system including an escape point, an air-supply connection configured to be connected to an air supply, the fluid recovery system comprising:
a reservoir including:
an inlet coupled to the escape point;
an outlet coupled to the main fluid system;
an exit port coupled to the pump; and
an input port coupled to the air-supply connection.

33. A molding system, comprising:
a pump;
a main fluid system including an escape point;
an air-supply connection configured to be connected to an air supply; and
a fluid recovery system, including:
a reservoir including:
an inlet coupled to the escape point;
an outlet coupled to the main fluid system;
an exit port coupled to the pump; and
an input port coupled to the air-supply connection.

34. A method of a molding system having a pump, a main fluid system including an escape point, an air-supply connection configured to be connected to an air supply, and a fluid recovery system, the fluid recovery system including a reservoir, the reservoir including an inlet, an outlet, an exit port, and an input port, the method comprising:
coupling the inlet to the escape point;
coupling the outlet coupled to the main fluid system;
coupling the exit port coupled to the pump; and
coupling the input port coupled to the air-supply connection.

35. A molded article manufactured by usage of a fluid recovery system of a molding system having a pump, a main fluid system including an escape point, an air-supply connection configured to be connected to an air supply, the fluid recovery system comprising:
a reservoir including:
an inlet configured to be coupled to the escape point;
an outlet configured to be coupled to the main fluid system;
an exit port configured to be coupled to the pump; and
an input port configured to be coupled to the air-supply connection.

36. A molded article manufactured by usage of a molding system, the molding system comprising:
a pump;
a main fluid system including an escape point;
an air-supply connection configured to be connected to an air supply; and
a fluid recovery system, including:
a reservoir including:
an inlet coupled to the escape point;
an outlet coupled to the main fluid system;
an exit port coupled to the pump; and
an input port coupled to the air-supply connection.

37. A molded article manufactured by usage of method of a molding system having a pump, a main fluid system including an escape point, an air-supply connection configured to be connected to an air supply, and a fluid recovery system, the fluid recovery system including a reservoir, the reservoir including an inlet, an outlet, an exit port, and an input port, the method comprising:
coupling the inlet to the escape point;
coupling the outlet coupled to the main fluid system;
coupling the exit port coupled to the pump; and
coupling the input port coupled to the air-supply connection.
